(19) United States
(12) Patent Application Publication
(10) Pub. No.: US 2022/0154496 A1
(43) Pub. Date: May 19, 2022

(54) MULTI-COMPONENT LOCK FOR SECURING A DEVICE

(71) Applicant: ACCO Brands Corporation, Lake Zurich, IL (US)

(72) Inventors: Brian Bautista, South San Francisco, CA (US); Erica Serna, Livingston, CA (US)

(21) Appl. No.: 17/525,519

(22) Filed: Nov. 12, 2021

Related U.S. Application Data
(60) Provisional application No. 63/114,141, filed on Nov. 16, 2020.

(51) Int. Cl. E05B 73/00

(52) U.S. Cl. CPC E05B 73/0005; E05B 73/0082

(57) ABSTRACT

A lock to secure a device having an aperture includes a first inner lock member including a first body having a first end and a second end, and a first bore extending through the first body. The lock also includes a second inner lock member including a second body having a first end and a second end, and a second bore extending through the second body. Both the first ends of the first inner lock member and of the second inner lock member are configured to be inserted into the aperture of the device. The lock further includes an outer lock member including a third body positioned around at least portions of the second ends of the first inner lock member and the second inner lock member, and a security device inserted through the first bore and the second bore to inhibit removal of the lock from the device.

### CROSS-REFERENCE TO RELATED APPLICATIONS

This application claims priority to U.S. Provisional Application No. 63/114,141, filed Nov. 16, 2020, the entire contents of which are incorporated by reference herein.

### FIELD OF THE INVENTION

The present invention relates to a multi-component lock used to secure a device having an aperture.

### BACKGROUND OF THE INVENTION

A Mac Pro® computer and Pro Display are devices sold by Apple®, in which, the Mac Pro® is a computer tower with an electronic portion and the Pro Display is a computer monitor. Both devices are encased by a housing having spherical cutouts that intersect to create through holes for venting.

### SUMMARY OF THE INVENTION

The present invention provides, in one aspect, a lock to secure a device having an aperture. The lock includes a first inner lock member including a first body having a first end configured to be inserted into the aperture and a second end. The first inner lock member defines a first bore extending through the first body. The lock also includes a second inner lock member including a second body having a first end configured to be inserted into the aperture and a second end. The second inner lock member defines a second bore extending through the second body. The lock further includes an outer lock member including a third body positioned around at least portions of the second end of the first inner lock member and the second end of the second inner lock member, and a security device inserted through the first bore and the second bore to inhibit removal of the lock from the device.

The present invention provides, in another aspect, a lock to secure a device having an aperture. The lock includes a first inner lock member including a first body having a first end configured to be inserted into the aperture and a second end. The first end defines a first substantially arcuate portion that is a portion of a sphere. The lock also includes a second inner lock member including a second body having a first end configured to be inserted into the aperture and a second end. The second end defines a second substantially arcuate portion that is a portion of a sphere. The lock further includes an outer lock member including a third body positioned around at least portions of the second end of the first inner lock member and the second end of the second inner lock member.

The present invention provides, in yet another aspect, a method for securing a lock to a device having an aperture. The lock includes a first inner lock member having a first body with a first end, a second end, and a first bore extending through the first body. The lock also includes a second inner lock member having a second body with a first end, a second end, and a second bore extending through the second body. The lock further includes an outer lock member having a third body, and a security device. The method includes inserting the first end of the first inner lock member into the aperture of the device and inserting the first end of the second inner lock member into the aperture of the device. The method further includes positioning the third body of the outer lock member around at least portions of the second end of the first inner lock member and the second end of the second inner lock member. Moreover, the method includes inserting the security device through the first bore and the second bore to inhibit removal of the lock from the device.

Other features and aspects of the invention will become apparent by consideration of the following detailed description and accompanying drawings.

### BRIEF DESCRIPTION OF THE DRAWINGS

FIG. 1A illustrates a system including a portion of a computer and a lock according to one embodiment, the lock coupled to a portion of the computer and receiving a security device.

FIG. 1B illustrates the system of FIG. 1A further including a bracket coupled to the lock.

FIG. 2A is a perspective view of the computer of FIG. 1A including a monitor and tower.

FIG. 2B is a partially exploded view of the tower of FIG. 2A.

FIG. 3 is a perspective view of the lock of FIG. 1A.

FIG. 4 is a perspective view of the lock of FIG. 1A and the bracket of FIG. 1B.

FIG. 5 is another perspective view of the lock of FIG. 1A and the bracket of FIG. 1B.

FIG. 6 is another perspective view of the lock of FIG. 1A and the bracket of FIG. 1B.

FIG. 7 is an exploded view of a first inner lock member and a second inner lock member of the lock of FIG. 1A.

FIG. 8 is a perspective view of the first inner lock member and the second inner lock member of the lock of FIG. 1A.

FIG. 9 is another perspective view of the first inner lock member and the second inner lock member of the lock of FIG. 1A.

FIG. 10 is a perspective view of an outer lock member of the lock of FIG. 1A.

FIG. 11 is an exploded view of a lock according to another embodiment and the bracket of FIG. 1B, the lock configured to be coupled to a portion of the computer.

FIG. 12 is a side view of a first inner lock member and a second inner lock member of the lock of FIG. 11 positioned relative to the computer in a second position.

FIG. 13 is a side view of the first inner lock member and the second inner lock member of the lock of FIG. 11 positioned relative to the computer in a first position.

FIG. 14 is a perspective view of the first inner lock member, the second inner lock member, and an outer lock member of the lock of FIG. 11 positioned relative to the computer.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

### DETAILED DESCRIPTION

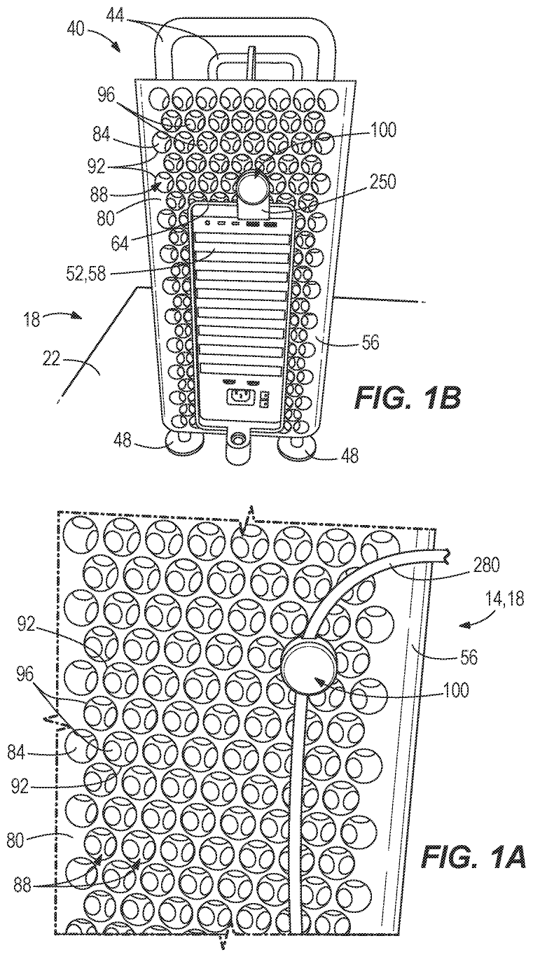

FIGS. 1A and 1B illustrate a lock 100 configured to secure a device to a structure 22. The device may be an electronic device, such as a computer tower, monitor, printer, server, television, portable electronic device, and the like. In some embodiments, the device may be a non-electronic device, such as a piece of furniture, a portable safe, or other object a user desires to secure in place. The structure 22 may be a relatively immovable object, such as a desk, table, cabinet, post or beam, bracket, and the like. The lock 100 secures the device to the structure 22 to inhibit removal of the device away from the structure 22.

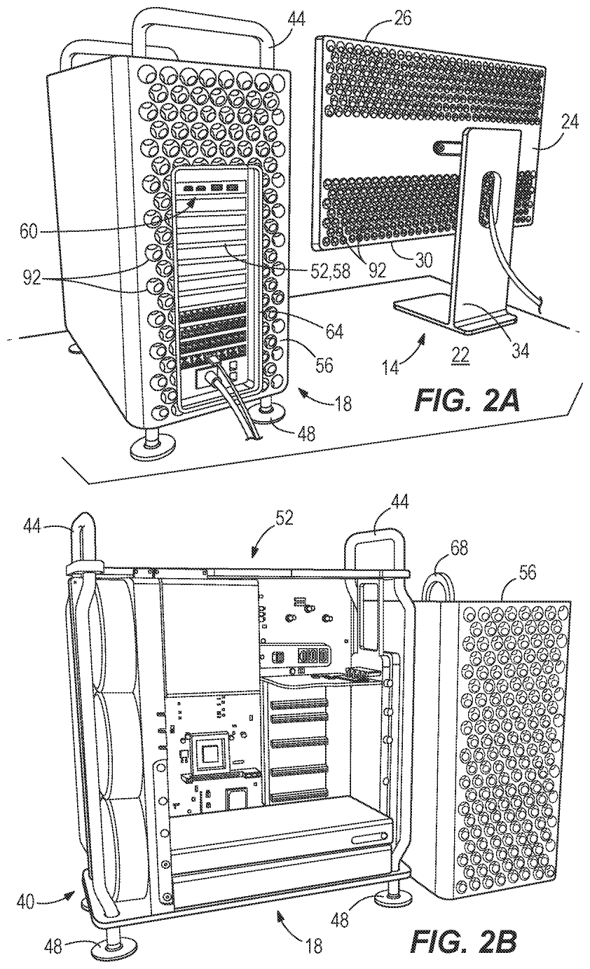

In the illustrated embodiment, the device is a personal computer. As shown in FIGS. 1A-2B, personal computers often include a monitor 14 that is in electrical communication with a tower 18, among other components. The illustrated computer monitor 14 is a Pro Display XDR® and the computer tower 18 is a Mac Pro® computer, which are both sold by Apple®, although the device may be any other computer or device. As shown in FIG. 2A, in the illustrated embodiment, the monitor 14 includes a housing 24 that has a first side 26, which supports a display (not shown), and a second side 30 opposite the first side 26. A stand 34 is coupled to the second side 30 to support the monitor 14. As shown in FIGS. 2A and 2B, in the illustrated embodiment, the tower 18 includes a frame 40 that defines a pair of handles 44 and one or more feet 48. The frame 40 supports an electronic portion 52 and a removable housing 56 that at least partially surrounds the electronic portion 52. The electronic portion 52 has a recess 58 in which one or more ports 60 are positioned. As shown, the housing 56 has a cut-out 64 that is sized and shaped to surround the recess 58 of the electronic portion 52. The cut-out 64 provides access to the one or more of the ports 60 of the electronic portion 52. The housing 56 also has an actuator 68 that enables a user to remove the housing 56 from the frame 40 such that the electronic portion 52 may be easily accessed.

With renewed reference to FIGS. 1A and 1B, in the illustrated embodiment, at least a portion of the housing 24, 56 of each of the monitor 14 and the tower 18 includes a first surface or wall 80 and a second surface or wall 84 that is spaced apart from first wall 80. The first wall 80 has a plurality of cut-outs 88, each defining an aperture 92. The second wall 84 includes a plurality of apertures 96 that are spaced apart from one another. Each of the apertures 92 overlaps at least one of the apertures 96 in the second wall 84. The overlapping apertures 92, 96 of the first wall 80 and the second wall 84 create vents that allow heat dissipation. In the illustrated embodiment, the cut-outs 88 are substantially spherical and the apertures 92 are substantially circular; in other embodiments, the cut-outs 88 and apertures 92 may be any suitable shape. Moreover, while the second wall 84 includes a plurality of apertures 96 in the illustrated embodiment, in other embodiments, the second wall 84 may have other suitable configurations. That is the second wall 84 may include a plurality of recesses, ledges or projections and the like, or may omit apertures, recesses, or projections, and the like. As shown in FIGS. 1A and 1B, the lock 100 is securable to the monitor 14 or to the tower 18 of the computer. In particular, the lock 100 is positioned at least partially within one of the first plurality of the apertures 92, as will be discussed herein.

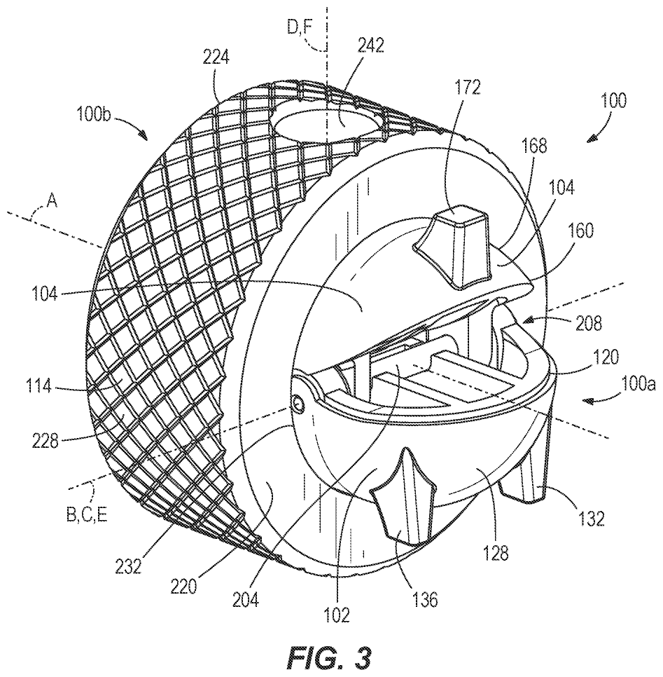

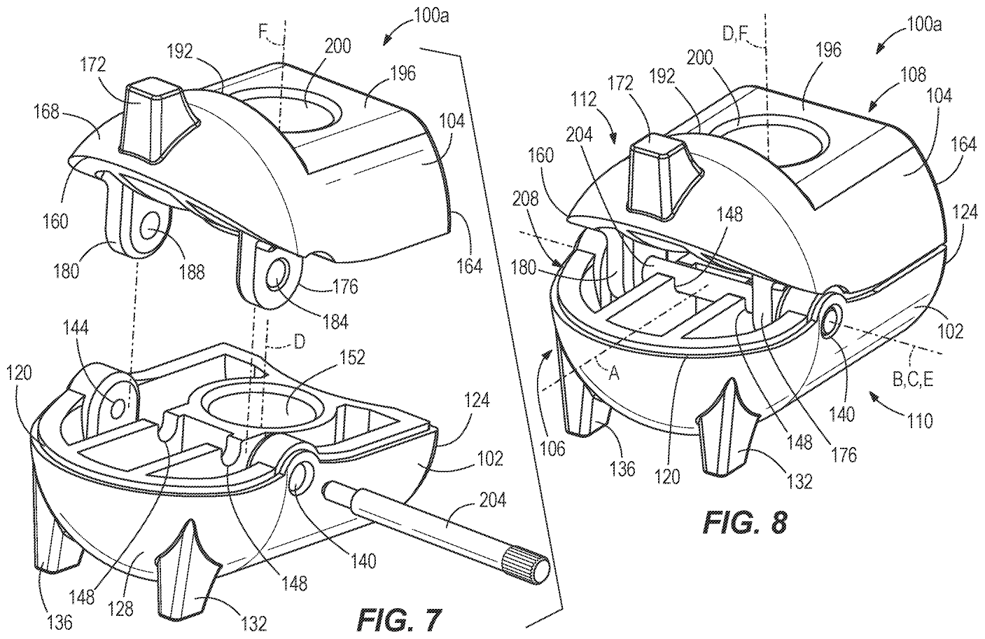

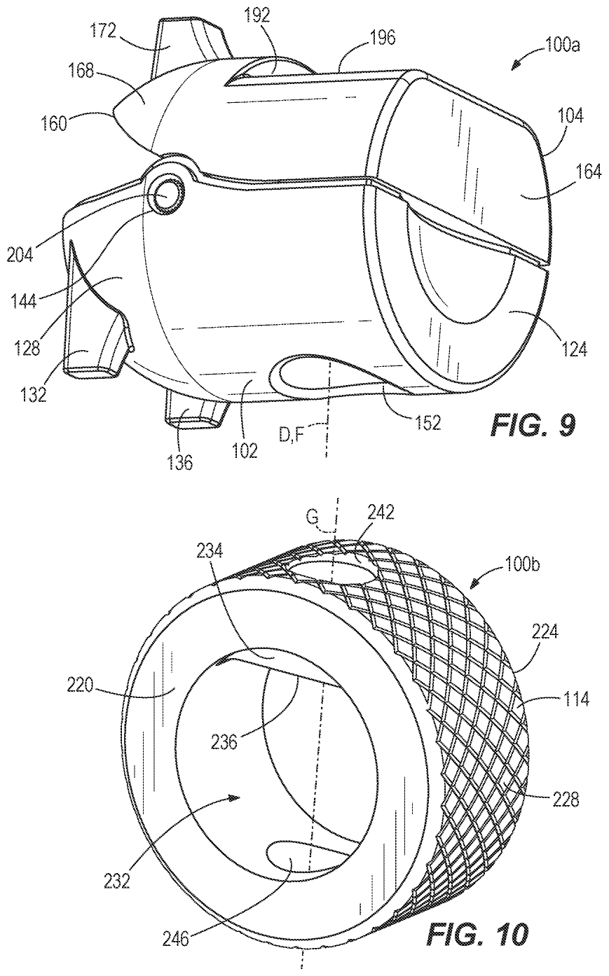

With respect to FIGS. 3-10, the lock 100 is a multi-component lock. As shown, the lock 100 includes an inner lock portion 100a and an outer lock portion 100b that receives at least a portion of the inner lock portion 100a. The inner lock portion 100a includes a first inner lock member 102, a second inner lock member 104, a longitudinal axis A, and a transverse axis B. With respect to FIG. 8, the longitudinal axis A extends between opposite ends 106, 108 of the inner lock portion 100a, and the transverse axis B extends between opposite sides 110, 112 of the inner lock portion 100a. The transverse axis B is perpendicular to the longitudinal axis A. The outer lock portion 100b includes an outer lock member 114.

The first inner lock member 102 includes a body that has a first end 120 and a second end 124 opposite the first end 120. The first end 120 and the second end 124 are aligned parallel to the longitudinal axis A. In the illustrated embodiment, the first end 120 defines a substantially arcuate portion 128. The illustrated arcuate portion 128 is a portion of a sphere. The first end 124 includes a first projection 132 and a second projection 136 extending from the actuate portion 128. The first and second projections 132, 136 are on opposite sides of the body from one another. In other embodiments, the first end 120 may include fewer or additional projections. A first aperture 140 extends through a first side of the body and a second aperture 144 extends through a second, opposite side of the body. Additionally, at least one recess 148 is defined within the body of the first inner lock member 102. In the illustrated embodiment, there are two recesses 148, but in other embodiments, there may be fewer or greater than two recesses 148. The first aperture 140, the second aperture 144, and the recesses 148 are aligned along an axis C. A bore 152 extends through the body of the first inner lock member 102 along an axis D, which is perpendicular to an axis C. The bore 152 is positioned between the first end 120 and the second end 124.

Further with respect to FIGS. 3-10, the second inner lock member 104 includes a body that has a first end 160 and a second end 164 opposite the first end 160. The first end 160 is positioned at an angle relative the second end 160 and relative to the longitudinal axis A. In the illustrated embodiment, the first end 160 defines a substantially arcuate portion 168. The illustrated arcuate portion 168 is a portion of a sphere. The first end 160 includes a projection 172 extending from the actuate portion 168. In other embodiments, the first end 160 may include additional projections. A first extension 176 extends from a first side of the body and a second extension 180 extends from a second side of the body. The first and second extension 176, 180 are positioned between the first end 160 and the second end 164. The first extension 176 includes a first aperture 184 and the second extension 180 includes a second aperture 188. The first and second apertures 180, 188 are aligned along an axis E. The second inner lock member 104 further includes a stop surface or ledge 192 that is positioned between the first end 160 and the second end 164. Moreover, a substantially flat or planar surface 196 extends from the stop surface 192 to the second end 164. A bore 200 extends through the body of the second inner lock member 104 along an axis F, which is perpendicular to the axis E. The bore 200 is defined between the stop surface 192 and the second end 164.

In the embodiment of FIGS. 3-10, the first inner lock member 102 and the second inner lock member 104 are movably (e.g., pivotably, hingedly, rotatably, etc.) coupled to one another by a fastener 204 (e.g., a pin). The first inner lock member 102 is positioned relative to the second inner lock member 104 such that the first and second extensions 176, 180 of the second inner lock member 104 are positioned within the body of the first inner lock member 102. The first extension 176 of the second inner lock member 104 is positioned adjacent the first side of the first inner lock member 102 such that first apertures 140, 184 are aligned. Similarly, the second extension 180 of the second inner lock member 104 is positioned adjacent the second side of the first inner lock member 102 such that the second apertures 144, 188 are aligned. When coupled, the axes C, E of the first and second inner lock members 102, 104 are coincident with one another and coincident with the transverse axis B. The fastener 204 is secured within the first aperture 140 of the first inner lock member 102, extends through the first and second apertures 184, 188 of the second inner lock member 104, and is secured within the second aperture 144 of the first inner lock member 102. The recesses 148 assist in supporting the fastener 204. The fastener 204 therefore extends along the transvers axis B and allows the second inner lock member 104 to move (e.g., pivot, hinge, rotate, etc.) relative to the first inner lock member 102 about the transverse axis B.

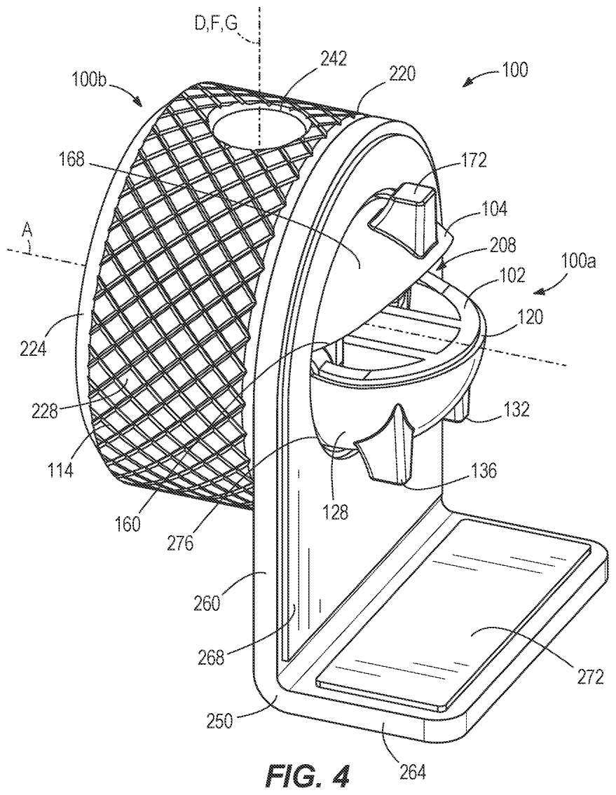

The inner lock portion 100a is movable between a first position and a second position. When in the first position (as shown in FIGS. 3-4), the inner lock portion 100a is configured to be secured to the device. More particularly, the inner lock portion 100a is expanded to inhibit removal from one of the apertures 92 in the monitor 14 or the tower 18 (FIG. 2A). When in the second position, the inner lock portion 100a is configured to be inserted into or removed from the device. More particularly, the inner lock portion 100a is collapsed to allow insertion into or removal from one of the apertures 92 in the monitor 14 or the tower 18. As noted above, the apertures 92 are generally spherical in shape, and the arcuate portions 128, 168 of the first and second inner lock members 102, 104 also form portions of spheres to match the shape and size of one of the apertures 92. In other embodiments, the arcuate portions 128, 168 of the first and second inner lock members 102, 104 may have other configurations (e.g., shapes and/or sizes) to interface with different types of apertures.

In the first position, the first end 160 of the second inner lock member 104 is spaced apart from the first end 120 of the first inner lock member 102 by a gap 208, and the second end 164 of the second inner lock member 104 is positioned adjacent the second end 124 of the first inner lock member 102. In the first position, axes D, F of the bores 152, 200 of the first inner lock member 102 and the second inner lock member 104 are coincident or aligned with one another and oriented perpendicular to both the longitudinal and transverse axes A, B. The projection 172 of the second inner lock member 104 is positioned at a substantially perpendicular angle relative to the longitudinal axis A in the first position.

In the second position, the first end 160 of the second inner lock member 104 is positioned adjacent the first end 120 of the first inner lock member 102, and the second end 164 of the second inner lock member 104 is spaced apart from the second end 124 of the first inner lock member 102 by a gap. In the second position, the bores 152, 200 are not aligned, and the projection 172 of the second inner lock member 104 is positioned at a non-perpendicular angle relative to the longitudinal axis A. Whether in the first or the second position, the first and second projections 132, 136 of the first inner lock member 102 are positioned a substantially perpendicular angle relative to the longitudinal axis A.

As shown in FIG. 10, the outer lock member 114 includes a body having a first end 220 and a second end 224. An outer wall 228 extends between the first end 220 and the second end 224. A recess 232 extends from the first end 220 into the body. An inner wall 234 extends into the recess 232. The inner wall 234 at least partially defines a key or guide surface 236. A first bore 242 extends through the outer wall 228 and is in communication with the recess 232, and a second bore 246 extends through the outer wall 228 and is in communication with the recess 232. The first bore 242 extends through the guide surface 236 in the illustrated embodiment. The first and second bores 242, 246 are aligned along an axis G.

The recess 232 is configured to receive the inner lock portion 100a when the inner lock portion 100a is in the first position. That is, as shown in FIGS. 3-6, the recess 232 is configured to receive the second ends 124, 164, respectively of each of the first inner lock member 102 and the second inner lock member 104 such that the first and second bores 242, 246 of the outer lock member 114 are aligned with the bores 152, 200 of the first and second inner lock members 102, 104 along the respective axes D, F, G. Moreover, the guide surface 236 of the outer lock member 114 is configured to mate with the flat surface 196 of the second inner lock member 104 to ensure proper positioning of the bores 242, 246 of the outer lock member 114 relative to the bores 152, 200 of the first and second inner lock members 102, 104. The stop surface 192 of the second inner lock member 104 rests against the inner wall 234.

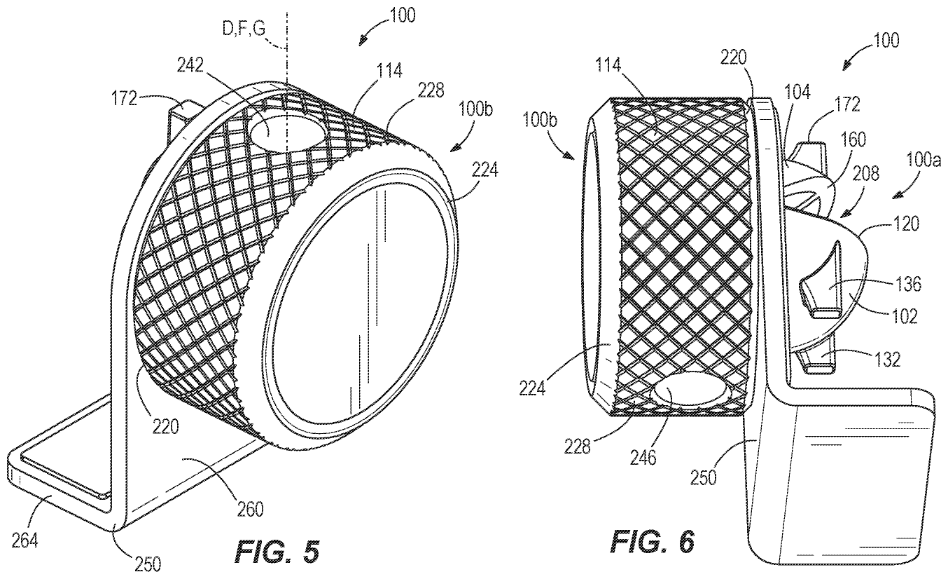

Referring back to FIGS. 4-5, in some embodiments, the lock 100 may further include a bracket 250. In the illustrated embodiment, the bracket 250 is a L-shaped bracket having a first leg 260 and a second leg 264 that is perpendicular to the first leg 260. Each of the first and second legs 260, 264 may include a pad or cushioning member 268, 272. The first leg 260 is longer than the second leg 264. The first leg 260 defines an aperture 276 extending therethrough. The aperture 276 is sized and shaped to be receive the inner lock portion 100a, but not the outer lock portion 100b.

To use the lock 100 of FIGS. 3-10, the user moves the inner lock portion 100a from the first position to the second position, positions the first end 106 of the inner lock portion 100a relative to the monitor 14 or tower 18, and then moves the inner lock portion 100a from the second position to the first position. Specifically, once the inner lock portion 100a is in the second position, the first ends 120, 160 of the first and second inner lock members 102, 104 are positioned within one of the apertures 92 of the first plurality of apertures 92 in either the monitor 14 or the tower 18. In the illustrated embodiment, the first ends 120, 160 are positioned such that the first and second projections 132, 136 of the first inner lock member 102 are simultaneously positioned within adjacent apertures 96 of the second plurality of apertures 96. Moving the inner lock portion 100a from the second position back to the first position causes the projection 172 of the second inner lock member 104 to become positioned within another aperture 96 of the second plurality of apertures 96. The projections 132, 136, 172 of the first and second inner lock members 102, 104 are thus configured to engage the second wall 84, and specifically edges of the apertures 96 of the second wall 84, of the housing 24, 56 of the monitor 14 or tower 18, respectively, to retain the inner lock portion 100a relative to the monitor 14 or the tower 18. In other embodiments, the projections 132, 136, 172 may simultaneously engage other suitable structures (e.g., recesses, ledges, or projections and the like) of the second wall 84 or may be merely positioned between the first and second walls 80, 84 (e.g., within the housing 24, 56 of the monitor 14 or tower 18 and adjacent the first wall 80).

When the inner lock portion 100a is positioned relative to the monitor 14 or the tower 18, the user then positions the outer lock portion 100b relative to the inner lock portion 100a. That is, the user inserts the second ends 124, 164 of the first and second inner lock members 102, 104 (which are in the first position) into the recess 232 of the outer lock member 114 to align the bores 152, 200 of the first and second inner lock members 102, 104 with the bores 242, 246 of the outer lock member 114. To do this, the user aligns the guide surface 236 of the outer lock member 114 within the flat surface 196 of the second inner lock member 102. The user then inserts an elongate security device 280 (e.g., security cable, rod, pad-lock, or the like) into the aligned bores 152, 200, 242, 246 of the inner and outer locking portions 100a, 100b to secure the monitor 14 or tower 18 to the structure 22. The security device 280 is coupled to the structure 22 to inhibit movement of the monitor 14 or tower 18 with the attached lock 100 away from the structure 22.

The lock 100 may be used with or without the L-shaped bracket 250. If the L-shaped bracket 250 is used, however, the aperture 276 of the first leg 260 is positioned adjacent to and aligned with the desired aperture 92 of the first plurality of apertures 92 and the second leg 264 is positioned to inhibit removal of the housing 56 of the tower 18 from the frame 40. Specifically, the second leg 264 engages edges of the recess 58 of the electrical portion 52 and the cut-out 64 of the housing 56 of the tower 18 to inhibit removal of the housing 56 from the frame 40. Once the bracket 250 is appropriately positioned, the inner lock portion 100a is inserted into the desired aperture and the lock 100 is secured via the outer lock portion 100b and the security device 280, as previously discussed.

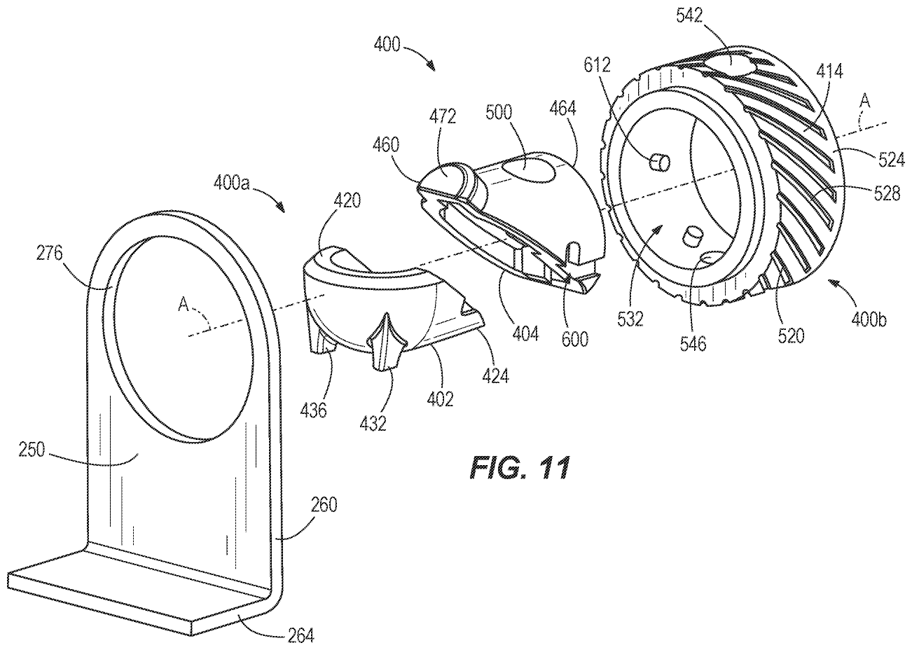

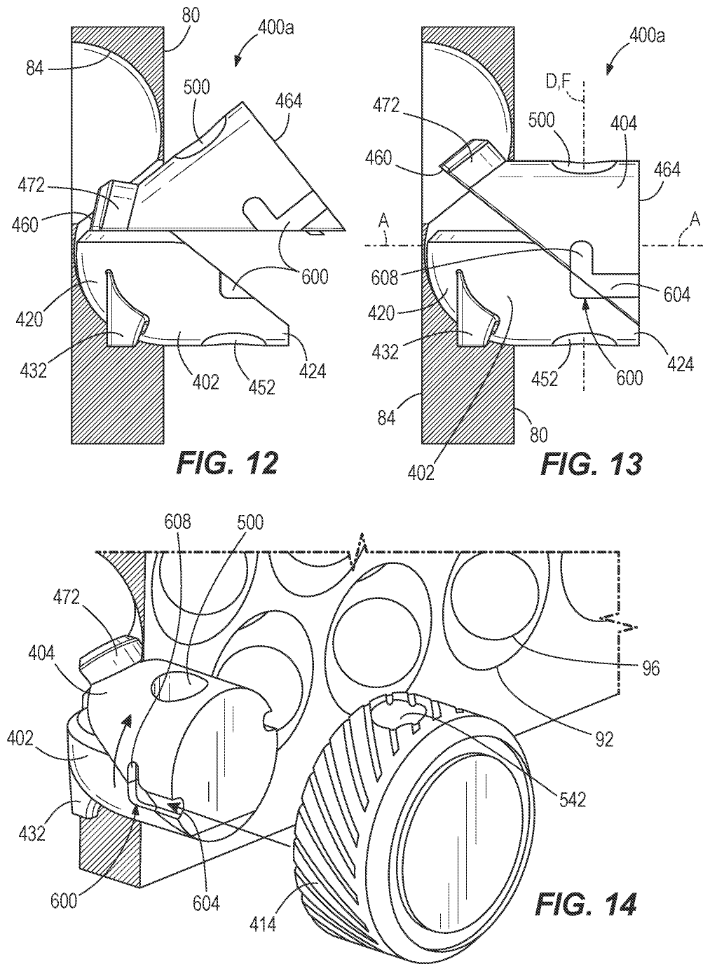

FIGS. 11-14 illustrate a lock 400 according to another embodiment of the invention. The lock 400 of FIGS. 11-14 is similar to the lock 100 of FIGS. 3-10; therefore, like structure will be identified by like reference numbers plus “300” and only the differences will be discussed hereafter.

In the embodiment of FIGS. 11-14, the first and second inner lock members 402, 404 are not coupled to another. Rather, the outer lock member 414 couples the first and second inner lock members 402, 404 together prior to positioning the security device 280 in the aligned bores 452, 500, 542, 546. As shown, a L-shaped slot 600 is formed on the first side of the inner lock portion 400a. In the illustrated embodiment, the L-shaped slot 600 includes a first slot portion 604 and second slot portion 608. The first slot portion 604 is substantially parallel to the longitudinal axis A and the second slot portion 608 is perpendicular to the first slot portion 604. In the illustrated embodiment, at least a part of the slot 600 is formed in each of the first and second inner lock members 402, 404. Although only the first side of the inner lock portion 400a is shown herein, it should be understood that the second side of the inner lock portion 400a may include a L-shaped slot, as well, configured in a similar way as the L-shaped slot 600 of the first side.

The outer lock member 414 includes a body with a first end 520 and a second end 524, an outer wall 528, and at least one projection 612 extending from a surface of the recess 532. The projection 612 is configured to be received in the L-shaped slot 600. The projection 612 that is received in the identified L-shaped slot 600 in the first side of the inner lock portion 400a is not specifically shown in FIGS. 11-14, but it should be understood that is similar to the projection 612 that is shown in FIGS. 11-14 and is positioned opposite the projection 612 so as to be received in the L-shaped slot 600 in the first side of the inner lock portion 400a. When the projection 612 is received at a closed end of the second slot portion 608, the bores 542, 546 of the outer lock member 414 are configured to align with the bores 452, 500 of the first and second inner lock members 402, 404.

To use the lock 400a of FIGS. 11-14, the user positions the inner lock portion 400a relative to the monitor 14 or tower 18. Specifically, the first end 420 of the first inner lock member 402 is positioned within a desired aperture 92 of the first plurality of apertures 92 in the monitor 14 or tower 18 such that the first and second projections 432, 436 of the first inner lock member 402 are simultaneously positioned within adjacent apertures 96 of the second plurality of apertures 96 of the monitor 14 or tower 18. Then, the second inner lock member 404 is positioned relative to the first inner lock member 402 by positioning the first projection 472, such that the first projection 472 is substantially parallel to the longitudinal axis A, inserting the first end 460 and projection 472 of the second inner lock member 404 into the desired aperture 92, and moving or pivoting the second end 464 of the second inner lock member 404 such that the second end 464 is adjacent the second end 424 of the first inner lock member 402. Once the second inner lock member 404 is positioned relative to the first inner lock member 402, the first and second slot portions 600, 604 of the same are positioned relative to one another to define the slot 600 and the bores 452, 500 are also aligned. The projections 432, 436, 472 of the first and second inner lock members 402, 404 are thus configured to engage the second wall 84, and specifically edges of the apertures 96 of the second wall 84, of the housing 24, 56 of the monitor 14 or tower 18, respectively, to retain the inner lock portion 400a relative to the monitor 14 or the tower 18. In other embodiments, the projections 432, 436, 472 may simultaneously engage other suitable structures (e.g., recesses, ledges, or projections and the like) of the second wall 84 or may be merely positioned between the first and second walls 80, 84 (e.g., within the housing 24, 56 of the monitor 14 or tower 18 and adjacent the first wall 80).

When the inner lock portion 400a is positioned relative to the monitor 14 or tower 18, the user then positions the outer lock portion 400b relative to the inner lock portion 400a. That is, the user inserts the second ends 424, 464 of the first and second inner lock members 402, 404 into the recess 532 of the outer lock member 414 to align the bores 452, 500 of the first and second inner lock members 402, 404 with the bores 542, 546 of the outer lock member 414. To do this, the user aligns the projection 612 with the first slot portion 604, slides or translates the outer lock member 414 relative to the first and second inner lock members 402, 404 such that the projection 612 is guided along the first slot portion 604 of the slot 600, and then rotates the outer lock member 414 relative to the first and second inner lock members 402, 404 such that the projection 612 is guided along the second slot portion 608 of the slot 600.

When the projection 612 is received at a closed end of the second slot portion 608, the bores 452, 500 of the first and second inner lock members 402, 404 are aligned with one another. The user then inserts the elongate security device 280 into the aligned bores 452, 500, 542, 546 of the inner and outer locking portions 400a, 400b to secure the monitor 14 or tower 18 to the support surface 22. Like the lock 100 of FIGS. 3-10, the lock 400 of FIGS. 11-14 may be used with or without the L-shaped bracket 250, as discussed above.

Although some aspects have been described in detail with reference to certain preferred embodiments, variations and modifications exist within the scope and spirit of one or more independent aspects as described. Various features and advantages of the invention are set forth in the following claims.

What is claimed is:

1. A lock to secure a device having an aperture, the lock comprising:
a first inner lock member including a first body having a first end configured to be inserted into the aperture and a second end, the first inner lock member defining a first bore extending through the first body;
a second inner lock member including a second body having a first end configured to be inserted into the aperture and a second end, the second inner lock member defining a second bore extending through the second body;
an outer lock member including a third body positioned around at least portions of the second end of the first inner lock member and the second end of the second inner lock member, and
a security device inserted through the first bore and the second bore to inhibit removal of the lock from the device.

2. The lock of claim 1, wherein the first inner lock member and the second inner lock member are movable relative to each other between a first position, in which the first and second inner lock members are configured to be secured to the device, and a second position, in which the first ends of the first and second inner lock members are configured to be inserted into the aperture of the device.

3. The lock of claim 2, wherein, in the first position, the first end of the first inner lock member and the first end of the second inner lock member are spaced apart by a gap, and wherein, in the second position, the first end of the first inner lock member and the first end of the second inner lock member are adjacent.

4. The lock of claim 3, wherein, in the first position, the first bore and the second bore are aligned.

5. The lock of claim 2, wherein the first inner lock member and the second inner lock member are pivotable relative to each other between the first position and the second position.

6. The lock of claim 5, wherein the first inner lock member and the second inner lock member are pivotably coupled together by a fastener.

7. The lock of claim 1, wherein the outer lock member defines a third bore, and wherein the security device is also inserted through the third bore to inhibit removal of the lock from the device.

8. The lock of claim 1, wherein the third body of the outer lock member includes an outer wall and a recess defined by the outer wall, and wherein the recess is configured to receive the second end of the first inner lock member and the second end of the second inner lock member.

9. The lock of claim 8, wherein the outer lock member defines a third bore extending through the outer wall and in communication with the recess and a fourth bore extending through the outer wall and in communication with the recess, wherein the security device is also inserted through the third bore and the fourth bore to inhibit removal of the lock from the device.

10. The lock of claim 1, further comprising a bracket including a first leg and a second leg perpendicular to the first leg, wherein the first leg has an aperture configured to receive the first end of the first inner lock member and the first end of the second inner lock member, and wherein the second leg is configured to engage a portion of the device adjacent the aperture.

11. The lock of claim 1, wherein the first end of each of the first and second inner lock members defines a substantially arcuate portion that is a portion of a sphere.

12. The lock of claim 11, wherein the first end of the first inner lock member includes a first projection extending from the portion of the sphere, and wherein the first end of the second inner lock member includes a second projection extending from the portion of the sphere.

13. The lock of claim 1, wherein the security device includes a cable.

14. A lock to secure a device having an aperture, the lock comprising:
a first inner lock member including a first body having a first end configured to be inserted into the aperture and a second end, the first end defining a first substantially arcuate portion that is a portion of a sphere;
a second inner lock member including a second body having a first end configured to be inserted into the aperture and a second end, the second end defining a second substantially arcuate portion that is a portion of a sphere; and
an outer lock member including a third body positioned around at least portions of the second end of the first inner lock member and the second end of the second inner lock member.

15. The lock of claim 14, wherein the first end of the first inner lock member includes a first projection extending from the portion of the sphere, and wherein the first end of the second inner lock member includes a second projection extending from the portion of the sphere.

16. The lock of claim 14, wherein the first inner lock member and the second inner lock member are movable relative to each other between a first position, in which the first and second inner lock members are configured to be secured to the device, and a second position, in which the first ends of the first and second inner lock members are configured to be inserted into the aperture of the device.

17. The lock of claim 16, wherein the first inner lock member and the second inner lock member are pivotable relative to each other.

18. The lock of claim 14, further comprising a security member extending through the first inner lock member and the second inner lock member to inhibit removal of the lock from the device.

19. A method of securing a lock to a device having an aperture, the lock including a first inner lock member having a first body with a first end, a second end, and a first bore extending through the first body, a second inner lock member having a second body with a first end, a second end, and a second bore extending through the second body, an outer lock member having a third body, and a security device, the method comprising:
inserting the first end of the first inner lock member into the aperture of the device;
inserting the first end of the second inner lock member into the aperture of the device;
positioning the third body of the outer lock member around at least portions of the second end of the first inner lock member and the second end of the second inner lock member; and
inserting the security device through the first bore and the second bore to inhibit removal of the lock from the device.

20. The method of claim 19, further comprising:
prior to inserting the first end of the first inner lock member into the aperture of the device and inserting the first end of the second inner lock member into the aperture of the device, moving the first end of the first inner lock member adjacent the first end of the second inner lock member; and
after inserting the first end of the first inner lock member into the aperture of the device and inserting the first end of the second inner lock member into the aperture of the device, moving the first end of the first inner lock member apart from the first end of the second inner lock member.
